(19) United States
(12) Patent Application Publication
(10) Pub. No.: US 2009/0111336 A1
(43) Pub. Date: Apr. 30, 2009

(54) SPLIT CONNECTOR AND METHOD

(75) Inventors: David Johansson, Malmo (SE); Markus Gustav Agevik, Malmo (SE); Anders Lundquist, Malmo (SE); Anders Hansson, Klagerup (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/928,071

(22) Filed: Oct. 30, 2007

(51) Int. Cl. H01R 13/02

(52) U.S. Cl. 439/884

(57) ABSTRACT

A connection system for signals includes an electrical connector and a receptacle. The electrical connector includes an elongated plug portion having a plurality of electrical contacts arranged thereon, wherein a first and a second electrical contact of the plurality of electrical contacts are arranged circumferentially adjacent to one another, and a third electrical contact of the plurality of electrical contacts is arranged axially adjacent to first and second electrical contacts. The receptacle includes first, second and third electrical conductors arranged to electrically couple to the first, second and third electrical contacts of the electrical connector when the plug portion is inserted in the receptacle.

### TECHNICAL FIELD

The present invention relates generally to electronic devices, such as electronic devices for engaging in voice communications, rendering media content, playing games, etc. More particularly, the invention relates to a system connector for use with electronic devices.

### BACKGROUND

Mobile and/or wireless electronic devices are becoming increasingly popular. For example, mobile telephones, portable media players and portable gaming devices are now in wide-spread use. In addition, the features and accessories associated with certain types of electronic devices have become increasingly diverse. To name a few examples, many electronic devices have cameras, text messaging capability, Internet browsing capability, electronic mail capability, video playback capability, audio playback capability, image display capability and handsfree headset interfaces. Exemplary accessories may also include headphones, music and video input players, etc.

Many mobile and/or wireless electronic devices include connectors, such as audio connectors, to which accessories, such as, for example, handsfree headsets, headphones, etc. may be connected. Audio connectors and other type of connectors for such devices usually include one or more terminals or terminal portions of respective wires or of printed circuit traces, or the like via which electrical signals are conducted between a connector of the mobile phone, for example, and the connector of the accessory, for example. Electronic devices, for example, may include a number of such connectors to accommodate various accessories and/or functions of the electronic device.

A pervasive trend with electronic devices is the reduction in size and/or weight of such devices. For example, electronic devices employed in voice communications have reached dimensions that enable them to be comfortably placed in one's shirt or pants pocket, while at the same time packing the same or even more features than previous generation electronic devices.

### SUMMARY

A conventional electrical connector, such as a 2.5 millimeter (mm) connector or a 3.5 mm connector, may have three or four electrically conductive paths that are available for communicating signals. Such connectors may be used, for example, for audio signal connections, etc.

Sometimes it would be desirable to conduct more signals and/or to provide greater bandwidth for coupling between electronic devices and accessories than is available using conventional connectors. To provide additional signals, additional receptacles may be added to electronic device so as to enable additional connectors to be coupled to the electronic device (e.g., two or more receptacles may be provided to accept two or more audio connectors). However, as the dimensions of electronic devices are continuously reduced, the available space for receptacles, connectors and their corresponding cables also is reduced.

Briefly, in accordance with one aspect of the present invention, a system connector and corresponding socket, such as, for example, a 2.5 mm or 3.5 mm connector and socket, are split into multiple segments so as to provide additional poles for providing other functions, such as power and/or data communications. Moreover, the connector and socket configuration maintain backwards compatibility with conventional system connectors.

According to one aspect of the invention, an electrical connector includes an elongated plug portion having a plurality of electrical contacts arranged thereon, wherein a first and a second electrical contact of the plurality of electrical contacts are arranged circumferentially adjacent to one another, and a third electrical contact of the plurality of electrical contacts is arranged axially adjacent to first and second electrical contacts.

According to one aspect of the invention, the electrical connector further includes a first insulator pair arranged between the first and second contacts.

According to one aspect of the invention, the electrical connector further includes a second insulator arranged on the plug portion between the third contact and the first and second contacts.

According to one aspect of the invention, a longitudinal axis of one at least one insulator of the insulator pair is parallel to a longitudinal axis of the plug portion.

According to one aspect of the invention, at least one contact of the plurality of contacts completely circumscribes the plug portion.

According to one aspect of the invention, the electrical connector further includes a mechanical key arranged in a fixed position relative to the plug portion.

According to one aspect of the invention, the electrical connector further includes a support adapted to support the at least one electrically conductive member in positional relation to a receptacle.

According to one aspect of the invention, the electrical connector is an audio connector of an electronic device.

According to one aspect of the invention, the electronic device is a portable electronic device.

According to one aspect of the invention, the electrical connector is a 2.5 mm audio connector or a 3.5 mm audio connector.

According to one aspect of the invention, a connection system for signals includes the electrical connector described herein, and a receptacle including first, second and third electrical conductors arranged to electrically couple to said first, second and third electrical contacts when said plug portion is inserted in said receptacle.

According to one aspect of the invention, the electrical connector includes a mechanical key and the receptacle includes a mechanical keyway, wherein when the plug portion is inserted into the receptacle, the mechanical key engages the mechanical keyway so as to place the first and second electrical contacts in a known orientation within the receptacle.

According to one aspect of the invention, a portable electronic device includes the connector system described herein.

According to one aspect of the invention, the connector system is a system for connecting audio signals by electrical conduction.

According to one aspect of the invention, the portable electronic device is a mobile phone.

According to one aspect of the invention, a method of increasing a number of electrical contacts on an audio connector that includes an elongated plug portion having a plurality of axially adjacent contacts includes: splitting at least one contact of the plurality of axially adjacent contacts into two or more contacts that are circumferentially adjacent to one another; and electrically isolating the circumferentially adjacent contacts.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.”

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a schematic illustration of the front of an exemplary portable communication device, e.g., in the form of a mobile phone.

FIG. 2 is an enlarged fragmentary view of an exemplary connector system in accordance with the invention.

FIG. 3 is a schematic block system diagram of circuitry of the mobile phone of FIG. 1 for carrying out operation thereof in a manner described below.

### DESCRIPTION

The interchangeable terms “electronic equipment” and “electronic device” include portable radio communication equipment. The term “portable radio communication equipment,” which hereinafter is referred to as a “mobile radio terminal,” as “portable electronic equipment,” or as a “portable communication device,” includes all equipment such as mobile telephones, pagers, communicators, electronic organizers, personal digital assistants (PDAs), smartphones, portable communication apparatus or the like.

In the present application, embodiments of the invention are described primarily in the context of a mobile telephone. However, it will be appreciated that the invention is not intended to be limited to the context of a mobile telephone and may relate to any type of appropriate electronic equipment, examples of which include a media player, a gaming device, PDA and a computer, etc.

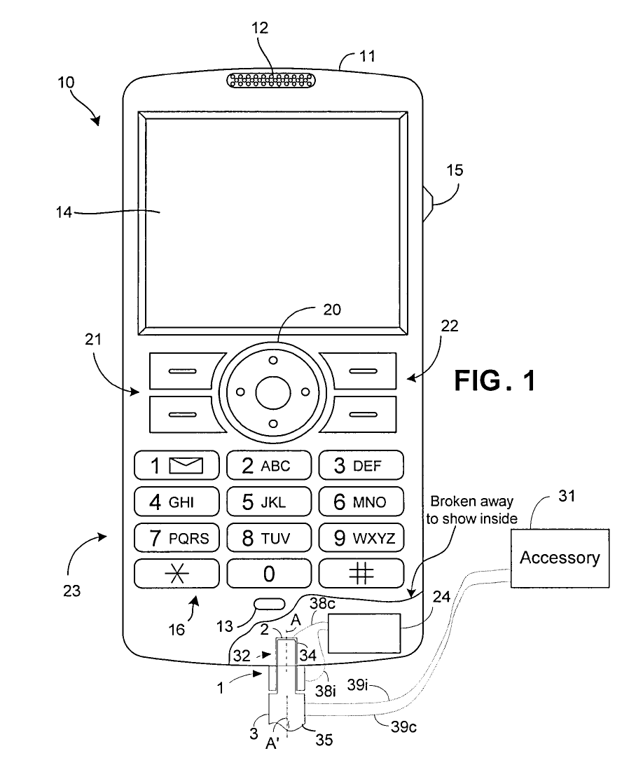

In FIGS. 1-3, as is described in greater detail below, an electrical connector system 1 includes two connector parts, 2, 3 that may be connected together to provide an electrically conductive connection of respective electrically conductive terminals or the like. The connector system 1 provides additional connectors or pins that may be used to increase signal bandwidth or to provide enhanced functionality. Moreover, the connector system 1 maintains backwards compatibility with conventional connector systems.

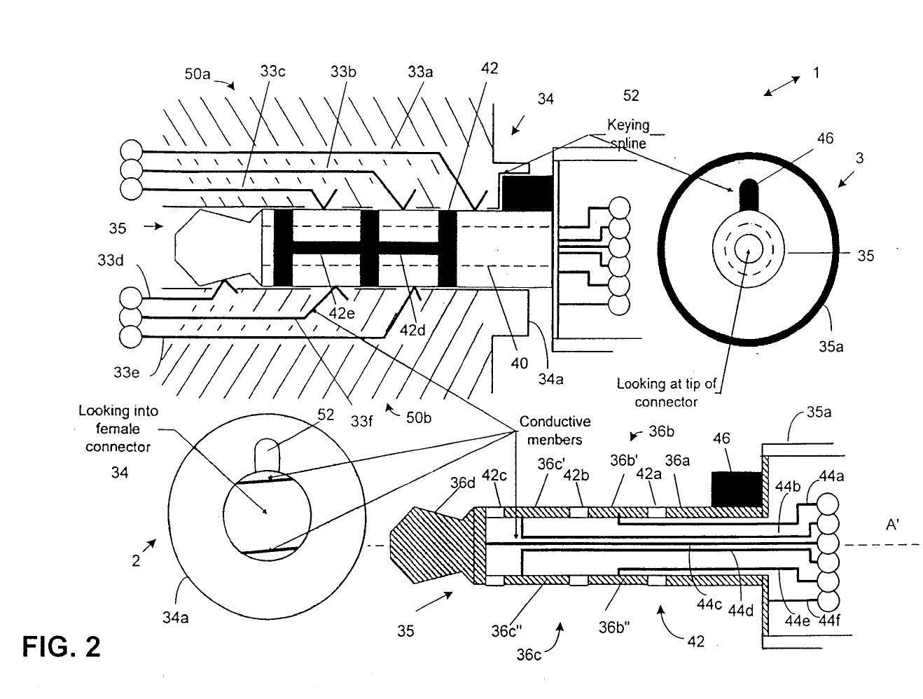

Referring in further detail to the FIGS. 1 and 2, a portable communication device in accordance with an embodiment of the present invention is illustrated generally at 10. The portable communication device 10 will be referred to below as a mobile phone. However, as was mentioned above, reference to “mobile phone” includes various other devices, such as, for example, those mentioned above. In outward appearance, for example, as is illustrated in FIG. 1, the mobile phone is of one type of design or style; however, the features of the invention, as are described in further detail below, may be used in other types of mobile phones, such as those that include cases that open and close (sometimes referred to as a “flip phone”), and various other mobile phones that currently exist or may come into existence in the future.

The mobile phone 10 includes case (housing) 11, speaker 12, microphone 13, display 14, e.g., liquid crystal display, light emitting diode display, or other display, on/off switch 15, and a number of keys generally indicated at 16. The keys 16 may include a number of keys having different respective functions. For example, the key 20 may be a navigation key, selection key or some other type of key; the keys 21, 22 may be, for example, soft switches or soft keys; and the keys 23 may be dialing keys. As an example, the navigation key may be used to scroll through lists shown on the display 14, to select one or more items shown in a list on the display 14, etc. The soft switches 21, 22 may be manually operated to carry out respective functions, such as those shown or listed on the display 14 in proximity to the respective soft switch or selected by the navigation key 20, etc. The dialing keys 23 may be used to dial a telephone number or to input alphanumeric or other data. The speaker 12, microphone 13, display 14, and keys 16 may be used and function in the usual ways in which a mobile phone typically is used, e.g. to initiate, to receive and/or to answer telephone calls, to send and to receive text messages, to connect with and carry out various functions via a network, such as the Internet or some other network, to beam information between mobile phones, etc. These are examples; there may be other uses that currently exist or may exist in the future.

The mobile phone 10 also includes operating circuitry 24 that responds to programming and to inputs, e.g., provided by a user pressing a key or applying a stylus or finger to a touch-sensitive screen, etc. or provided from an external source, such as an incoming telephone call or text message, to carry out functions of the mobile phone. As is seen in FIG. 1, part of the housing of the mobile phone is broken away to show an interior portion of the housing, including the operating circuitry 24 and the electrical connector system 1.

The electrical connector system 1 connects the mobile phone 10, e.g., the operating circuitry 24 thereof, with another device, e.g. an accessory 31, a remote device, etc. Such electrical connector system 1 provides for electrically conductive connection by an electrically conductive portion 32. The connector system 1 may be in the general form of an audio connector, for example, including both a female receptacle 34 and a male plug 35 that is intended to plug into the female receptacle. The female receptacle 34 and male plug 35 may include, respectively, one or more electrically conductive members or parts, e.g., wires, terminals, electrically conductive traces, etc. that respectively connect to each other by physical engagement and, thus, provide electrically conductive connection when the male plug 35 is plugged into the female receptacle 34. The female receptacle 34 has an axis A and the male plug has an axis A′ and the two axes align generally congruently, for example, when the male plug is inserted into the female receptacle.

With continued reference to FIGS. 1 and 2, the male plug 35 generally comprises an elongated member 40 (e.g., a pin) having electrical contacts 36a, 36b, 36c, and 36d (referred to generally as electrical contacts 36) axially arranged thereon. The electrical contacts 36 are electrically isolated from one another and from the elongated member 40 by insulators or the like (e.g., insulating washers). For example, a first contact 36a of the elongated member 40 is electrically isolated from an axially adjacent second contact 36b of the elongated member by a first insulator 42a. Similarly, the second contact 36b of the elongated member 40 is electrically isolated from an axially adjacent third contact 36c of the elongated member via a second insulator 42b, and the third contact 36c is electrically isolated from an axially adjacent fourth contact 36d by a third insulator 42c (the fourth contact 36d may form a tip or end of the male plug 35, and may be attached to the elongated member 40 via a threaded connection, for example). The first, second and third insulators 42a, 42b, 42c are circumferentially arranged about the longitudinal axis A′ of the elongated member 40 (e.g., each insulator encircles or surrounds a portion of the elongated member 40). Further, each of the first, second, third and fourth contacts are electrically isolated from the elongated member by a fifth insulator (e.g., an insulator (not shown) arranged around the elongated member).

At least one of the contacts, such as the second contact 36b and/or third contact 36c, is circumferentially split so as to form two or more electrical contacts 36b′, 36b″ and 36c″, 36c″, respectively, that are circumferentially adjacent to one another. First and second pairs of insulators 42d and 42e (only one insulator of each pair is shown in FIG. 2) electrically isolate the respective contact pairs. The first and second insulator pairs 42d, 42e can be oriented such that they are generally orthogonal to the first, second and/or third insulators 42a, 42b, 42c (e.g., the first and second insulator pairs can run generally parallel to the longitudinal axis A′ of the elongated member 40). It is noted that although the contacts 35b and 35c are circumferentially split into only two contacts (36b′, 36b″ and 36c′, 36c″, respectively), these contacts (and other contacts of the connector system 1) may be split into more contacts that include additional insulators between circumferentially adjacent contacts.

Electrically coupled to each of the contacts 36 are electrical conductors 44a-44f, (e.g., electrical wire). The electrical conductors 44a-44f may be attached to the respective contacts 36 via conventional methods.

The male plug 35 also includes a mechanical key or keying spline 46. As described below, the mechanical key 46 ensures proper orientation of the male plug 35 within the female receptacle 34 such that the additional contacts 36 of the male plug 35 correspond with additional pins of the female receptacle 34.

The female receptacle 34 comprises a plurality of pins 33a-33f (referred to generally as pins 33) arranged along a receptacle portion (e.g., a bore or slot) that receives the male plug 35. A first set of pins 33a-33c is arranged along a first side 50a (e.g., a top side) of the receptacle portion in a conventional orientation. This enables conventional male plugs, for example, to be used with the female receptacle 34 (i.e., the female receptacle is backwards compatible with conventional plugs). A second set of pins 33d-33f are arranged on a second side 50b (e.g., a bottom side) of the receptacle portion. Pins 33e and 33f of the second set of pins correspond to the circumferentially split contacts 36b″ and 36c″ of the male plug 35.

The female receptacle 34 also includes a mechanical keyway 52 corresponding to the mechanical key 46 of the male plug 35. The mechanical key 46 and keyway 52 of the connector system 1 ensure proper orientation of the male plug 35 with respect to the female receptacle 34 such that the additional contacts 36b″ and 36c″ of the male plug 35 make electrical contact with the pins 33e and 33f of the female receptacle 34. Moreover, the keyway 52 of the female receptacle does not inhibit a conventional male plug from being inserted therein, thus maintaining backwards compatibility, as described in more detail below.

The connector system 1 in accordance with the present invention is backwards compatible with conventional connector systems. For example, a conventional 3.5 mm audio plug may include four cylindrical contacts axially arranged along a plug portion of the audio plug (e.g., first, second, third and fourth cylindrical contacts). As the conventional plug is inserted into the female receptacle 34, pin 33e (which corresponds to the split contact 36b″) and pin 33b will be shorted together by the second cylindrical contact, and pins, and 33f (which corresponds to the split contact 36c″) and 33c will be shorted together by the third cylindrical contact. This short between the respective pins can be detected by a monitoring circuit of the operating circuitry 24, for example. The operating circuitry 24 then can configure the pins of the female receptacle 34 for conventional operation. However, if a male plug 35 in accordance with the present invention is inserted into the female receptacle 34, none of the pins will be shorted together. This also can be detected by the monitoring circuit, and the operating circuitry 24 then can proceed to configure the additional pins 36b″ and 36c″, for example, to transmit and/or receive additional data, provide power, etc.

It will be appreciated from the illustrations and description that the conductive portions 32 of the connector part 2, e.g., the female receptacle 34, is supported by the connector housing 34a that is attached to the mobile phone 10. Similarly, the conductive portions 32 of the male plug 35 also are supported by a male plug housing 35a or the like for similar reasons. Accordingly, the conductive portions of the connector parts 2 and 3 are supported or otherwise retained in a housing to allow for electrical connection between the respective parts.

The connector housing 34a of the female housing 34 and the housing 35a of the male plug 35 may be of a material that provides electromagnetic energy shielding so as to minimize interference with audio or other signals that are carried by or connected by the electrically conductive portion 32 of the connector system 1. The material of the housing 11 also may provide shielding for similar purposes, if desired.

With the male plug 35 plugged into the female housing 34, the respective pairs of electrically conductive members 33a-33c and 36a-36c are engaged and electrically connected for conduction. Connective paths 38c, 38i, e.g., wires, conductive traces on printed circuit boards, etc., from respective electrically conductive portions 32 are provided to the operating circuitry 24 of the mobile phone 10. Electrically conductive paths 39c, 39i, e.g., wires, conductive traces on printed circuit boards, etc., are provided to the accessory, remote device, etc. 31 from the electrically conductive portion 32.

Summarizing, the invention provides for transmitting data between an accessory and an electronic device, e.g., portable electronic equipment, such as a mobile phone, via an electrical connector that is similar in size and shape to an audio connector or audio jack. The approach may be used with conventional audio jacks or connectors and/or with other connectors whether or not of the audio type. The approach may be used, for example, with a 2.5 millimeter or 3.5 millimeter audio jack that may provide for fewer electrically conductive connections than other audio jacks.

Exemplary accessories may be headsets, mono or stereo headphones, external amplifier(s) and/or speaker(s), etc. Other types of accessories may be used with the connector 1 and mobile phone 10 to receive outputs from the connector and/or to provide inputs to the connector.

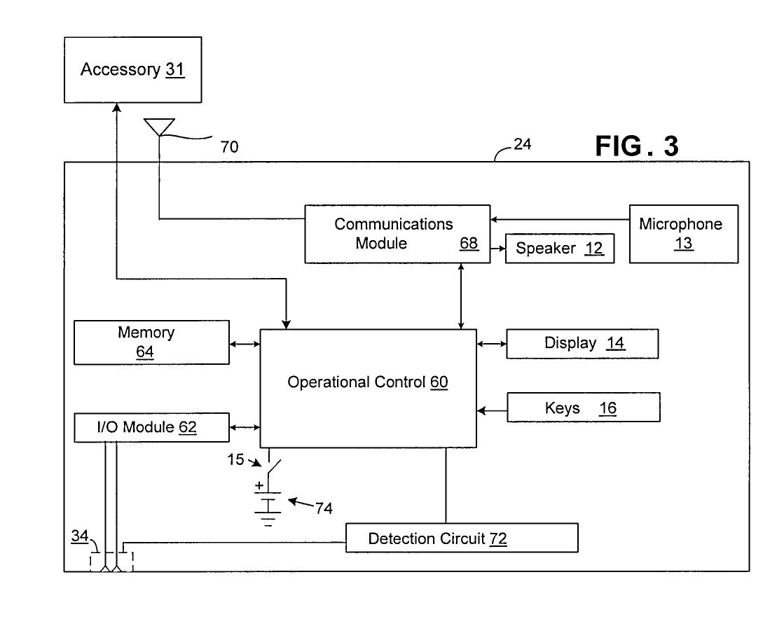

Turning to FIG. 3, a schematic block system diagram of operating circuitry 24 of the mobile phone 10 is illustrated. The illustration is exemplary; other types of circuitry may be employed in addition to or instead of the operating circuitry 24 to carry out the various functions of a mobile phone and the various functions described in detail herein. The operating circuitry includes an operational control 60 that controls the various components of the operating circuitry 24. An input module 62 provides inputs to the operational control 60, such as, for example, inputs from the various keys 16. Inputs also may be provided from the display 14 if it is a touch screen type of display, and inputs also may be provided the input module 62 from other connections to the mobile phone, etc. The display 14 may be a touch screen that provides for inputs to the input module 62 by touching using a finger, a stylus, or some other device, and the result of such touching may be provided as inputs to the operational control 60. The operational control 60 also may operate the display 14 to determine what information, icons, images, etc. is shown on the display 14.

The accessory 31 is coupled to the operating circuitry 24 via the connector system 1. More particularly, the accessory 31 is connected to the operational control 60 of the operating circuitry and operates in response to the operational control 60 and/or in response to receiving other suitable input. The accessory 31 also may provide input to the operating circuitry via the connector system 1.

Electrical power may be provided by the operational control 60 to the accessory 31. Program code in the operating circuitry 24, e.g., stored in the memory 64, may control operation of the operational control 60 to operate the accessory 31. Circuitry in and/or programming in the operating circuitry 24 and/or operational control 60 may determine various operational features of the mobile phone 10 and/or the accessory 31.

As an example, the operational control 60 may be a microprocessor or some other electrical or electronic device that is responsive to various inputs, e.g., input signals, and provides various outputs, e.g., output signals. The operational control 60 may be internally programmed or manufactured in a way to include internal programming thereof to carry out various functions. However, in many instances an operational control 60 of a mobile phone 10 would have associated therewith the memory 64 in which appropriate programming instructions, computer program, logic, etc., may be provided the operational control 60 to carry out the functions thereof. The memory may include identity information concerning respective accessories and settings of the operating circuitry in response to respective identity information. The memory 64 also may include storage for telephone numbers and other information concerning contacts who may be called, messaged, etc. using the mobile phone 10, storage of photographs and/or other data, as often is the capability of such memory in conventional mobile phones, for example, and the memory may be used for other purposes that may come into existence in the future. The memory 64 may be a read only memory, random access memory (RAM), flash RAM, programmable read only memory, or some other memory device. Also associated with the operational control 60 is a timer or clock 66 that can be used to provide timing signals representing increments of time for synchronizing operation of the operating circuitry 24 with some other device, for clock/calendar control functions, and/or for determining amount of time (duration) for the hold on function and/or for a screensaver function.

The operating circuitry 24 also includes a communications module 68 that receives inputs from microphone 13 and provides outputs to the speaker 12, as are common functions in a mobile phone. An antenna 70 may be coupled to the communications module 68 to transmit and to receive signals representing telephone communications, data communications, messages, etc. The communications module 68 may operate under control of the operational control 60 in the usual manner of a mobile phone. Additionally, the communications module 68 may provide an input to the operational control 60 to indicate that there is an incoming telephone call or text message; and in response thereto, the operational control 60 may operate the display 14 in conventional manner, e.g., to indicate an incoming phone call, to show a text message or photograph, etc.

The operating circuitry 24 also includes a detection circuit 72 that detects an electrical state of the pins 33 of the female receptacle 34. The detection circuit, for example, can be an impedance measuring circuit that measures the impedance between predetermined pins of the female receptacle 34. The measured impedance then can be provided to the operational control 60, which, based on the measured impedance, can configure the pins 33 of the female receptacle 34 for conventional operation or for enhanced operation.

A power supply 74 provides electrical power to the operating circuitry 24 and/or to other parts of the mobile phone 10 via the on/off switch 15. The power supply may be a conventional battery or some other source of electrical power. Upon closing the on/off switch 15, the power is provided the operating circuitry 24 to carry out the various functions described herein, for example. If desired, closing the switch 15 may lead to temporary operation of the display to display a start-up message or indication, and then a power saving feature, e.g., a screensaver function, may be implemented to turn off the display.

Operation of the mobile phone 10 may be under computer program control or the like. Such operation may be as is performed to carry out the functions of a mobile phone. Operation of the accessory 31 may be carried out under computer program control or the like. Such operation also may be as is performed in a conventional manner. The computer programs and computer program control may be carried out by persons who have ordinary skill in the art to prepare and to use such programs and control. New computer program control techniques and methods also may be developed in the future by persons having ordinary skill in the art and may be used in connection with the connector system and mobile phone and accessories.

It will be appreciated that portions of the present invention can be implemented in hardware, software, firmware, or a combination thereof. In the described embodiment(s), a number of the steps or methods may be implemented in software or firmware that is stored in a memory and that is executed by a suitable instruction execution system. If implemented in hardware, for example, as in an alternative embodiment, implementation may be with any or a combination of the following technologies, which are all well known in the art: discrete logic circuit(s) having logic gates for implementing logic functions upon data signals, application specific integrated circuit(s) (ASIC) having appropriate combinational logic gates, programmable gate array(s) (PGA), field programmable gate array(s) (FPGA), etc.

Any process or method descriptions may be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

The logic and/or steps described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

The above description and accompanying drawings depict the various features of the invention. It will be appreciated that the appropriate computer code could be prepared by a person who has ordinary skill in the art to carry out the various steps and procedures described above and illustrated in the drawings. It also will be appreciated that the various terminals, computers, servers, networks and the like described above may be virtually any type and that the computer code may be prepared to carry out the invention using such apparatus in accordance with the disclosure hereof.

Specific embodiments of an invention are disclosed herein. One of ordinary skill in the art will readily recognize that the invention may have other applications in other environments. In fact, many embodiments and implementations are possible.

The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. An electrical connector, comprising:
an elongated plug portion having an intermediate portion and an end portion electrically isolated from said intermediate portion;
a plurality of electrical contacts arranged on said intermediate portion, wherein a first and a second electrical contact of the plurality of electrical contacts are arranged circumferentially adjacent to one another, and a third electrical contact of the plurality of electrical contacts is arranged axially adjacent to said first and second electrical contacts,
and wherein the third electrical contact completely circumscribes the intermediate portion.

2. The electrical connector according to claim 1, further comprising a first insulator pair arranged between the first and second contacts.

3. The electrical connector according to claim 2, further comprising a second insulator arranged on the plug portion between the third contact and the first and second contacts.

4. The electrical connector according to claim 2, wherein a longitudinal axis of at least one insulator of the insulator pair is parallel to a longitudinal axis of the plug portion.

5. (canceled)

6. The electrical connector according to claim 1, further comprising a mechanical key arranged in a fixed position relative to the plug portion.

7. The electrical connector according to claim 1, further comprising a support adapted to support the at least one electrically conductive member in positional relation to a receptacle.

8. The electrical connector of claim 1, said electrical connector comprising an audio connector of an electronic device.

9. The electrical connector of claim 8, wherein the electronic device is a portable electronic device.

10. The electrical connector according to claim 1, wherein the electrical connector is a 2.5 mm audio connector or a 3.5 mm audio connector.

11. A connection system for signals, comprising
the electrical connector according to claim 1; and
a receptacle including first, second and third electrical conductors arranged to electrically couple to said first, second and third electrical contacts when said plug portion is inserted in said receptacle.

12. The connection system according to claim 11, wherein the electrical connector includes a mechanical key and the receptacle includes a mechanical keyway, wherein when the plug portion is inserted into the receptacle, the mechanical key engages the mechanical keyway so as to place the first and second electrical contacts in a known orientation within the receptacle.

13. A portable electronic device comprising the connector system of claim 18.

14. The portable electronic device of claim 13, said connector system comprising a system for connecting audio signals by electrical conduction.

15. The portable electronic device of claim 13, comprising a mobile phone.

16. (canceled)

17. The electrical connector according to claim 11, wherein said receptacle is backwards compatible with a standard 2.5 millimeter audio connector or a standard 3.5 millimeter audio connector.

18. An electrical connector, comprising:
a receptacle;
a first set of contacts located in said receptacle, said first set of contacts arranged in accordance with an audio coupling standard; and
a second set of contacts located in said receptacle, said second set of contacts not part of the audio coupling standard.

19. The connector according to claim 18, further comprising a detection circuit electrically coupled to at least one of the first set of contacts or the second set of contacts, said detection circuit adapted to determine if a plug inserted into the receptacle is in accordance with the audio coupling standard, and to configure the first and/or second set of contacts based on the determination.

20. The connector according to claim 18, wherein the audio coupling standard is a 2.5 millimeter audio coupling standard or a 3.5 millimeter audio coupling standard.

21. The connector according to claim 18, wherein said connector is backwards compatible with a standard 2.5 millimeter audio connector or a standard 3.5 millimeter audio connector.

22. The connector according to claim 18, wherein said second set of contacts are adapted to communicate at least one of power or data.
